(19) United States
(12) Patent Application Publication
(10) Pub. No.: US 2013/0033377 A1
(43) Pub. Date: Feb. 7, 2013

(54) FIRE DETECTOR FOR MONITORING A ROOM BY MEANS OF A COMBINATION OF SMOKE DENSITY MEASUREMENT AND TEMPERATURE MEASUREMENT

(71) Applicant: Winrich Hoseit, Koeln (DE)

(72) Inventor: Winrich Hoseit, Koeln (DE)

(21) Appl. No.: 13/641,594

(22) PCT Filed: Apr. 14, 2011
(86) PCT No.: PCT/EP11/01897

§ 371 Date: Oct. 16, 2012

(30) Foreign Application Priority Data
Apr. 16, 2010 (DE) 10 2010 015 467.9

(51) Int. Cl. G08B 17/10; G08B 1/08

(52) U.S. Cl. 340/539.22; 340/584

(57) ABSTRACT

A fire detector monitors a room and triggers a fire alarm. The fire detector has a smoke sensor and a temperature sensor for measuring a smoke density and a temperature. When a temperature threshold value and/or a smoke density threshold value is exceeded an alarm is triggered. The temperature threshold value is dependent on the smoke density and/or the smoke density threshold value is dependent on the temperature. The fire detector contains a memory. A complicated evaluation as to whether the temperature or smoke density threshold value has been exceeded is avoided and the risk of false alarms is reduced due to a stored matrix. The matrix contains combination values, and one of the combination values is assigned to the measured temperature and the measured smoke density. The combination value indicates whether the temperature threshold value and/or the smoke density threshold value has been exceeded or fallen below.

The invention relates to a fire detector for monitoring a room and for triggering a fire alarm, with a smoke sensor and with a temperature sensor, wherein a smoke density is measurable with the smoke sensor and a temperature is measurable with the temperature sensor, wherein, if a temperature threshold value is exceeded and/or a smoke density threshold value is exceeded, an alarm is triggerable, wherein the temperature threshold value is dependent on the smoke density and/or the smoke density threshold value is dependent on the temperature, wherein the fire detector has a memory.

In the prior art, smoke detectors are known which normally measure the smoke density and, if a predefined measurement value is exceeded, emit a time-limited audible alarm, and those that transmit a radio alarm to adjacent smoke detectors which then in turn also emit an audible alarm, and also those which then forward this information to a single connected transmission unit, such as a telephone or a GSM mobile radio network or a proprietary cable or network connection. If this audible alarm cannot be heard due to absence, a fire causing the alarm continues to spread; if this single connected transmission unit is defective, a transmission does not take place.

Fire detectors for monitoring a room and for triggering a fire alarm are known from U.S. Pat. No. 6,624,750 B1. The fire detectors have a photoelectric smoke sensor and a temperature sensor. An alarm is triggered if a predefined smoke density threshold value is exceeded or the ambient temperature exceeds 57° C. Each fire detector has a piezo loudspeaker, with which an audible alarm can be generated. The fire detectors are equipped in each case with a first radio means, i.e. a transceiver for transmitting and receiving information by means of radio. The fire detectors form a radio network. Furthermore, a transmission unit is similarly equipped with a first radio means. The transmission unit is connectable via a telephone connection to a destination address, i.e. a monitoring control center. Within the network, messages and information can either be forwarded directly to the transmission unit or can be forwarded from one fire detector to the next fire detector until the transmission unit is reached. The transmission unit transmits messages to the monitoring control center. The network comprising the fire detectors can therefore be connected via the single transmission unit to the monitoring control center.

The fire detector known from the prior art is not yet optimally designed. If the transmission unit fails, no alarm signal can be transmitted to the monitoring control center. The connection of the network to the monitoring control center is therefore susceptible to failure. In the event of only a slight build-up of smoke caused by food that has burnt in a kitchen, the risk exists of a false alarm being triggered. If a home is slightly filled with smoke, but no fire is present, a false alarm is triggered.

From the generic DE 601 10 746 T2, a fire detector is known with a smoke detector which detects a smoke density in a target environment; and with a temperature detector which detects a temperature of the target environment in order to determine a temperature difference within a predefined time interval. Furthermore, a threshold value means is provided to hold a multiplicity of main criteria for determining the presence of a fire, wherein the main criteria comprise:
(i) whether the smoke density exceeds a first smoke threshold;
(ii) whether the temperature difference exceeds a first temperature difference threshold; and
(iii) whether a combination of the smoke density and the temperature difference fulfils an inequality based on a decreasing function of the temperature difference with an increase in the smoke density.

A control device is furthermore provided which checks the detected temperature difference and the detected smoke density in relation to the main criteria, so that it supplies a fire warning signal which indicates a possible presence of a fire if one of the above main criteria is satisfied, wherein the fire alarm system can be operated in different operating modes which differ from one another through modification of at least one of the main criteria by modifying the first smoke threshold, the first temperature difference threshold and/or the inequality, wherein the control device is furthermore designed to check the detected temperature difference and the detected smoke density in relation to stringent criteria which are analogous to the main criteria but have lower threshold values and an inequality function which are in each case different from those of the main criteria in order to provide a fire index which indicates which of the stringent criteria have been satisfied in which number of events within a previous predefined time period, and wherein the control device is configured in such a way that it selects one of the different operating modes depending on this fire index.

This generic fire detector is not yet optimally designed. The evaluation of the main criteria requires a multiplicity of recalculations and comparisons and is correspondingly elaborate and susceptible to failure. Furthermore, an adaptation of the main criteria to the different operating modes is required.

The object of the invention is therefore to design and further develop a fire detector in such a way that the susceptibility to failure of the fire detector is reduced and an elaborate evaluation is avoided in determining whether the temperature threshold value or smoke density threshold value has been exceeded, wherein the risk of false alarms is significantly reduced.

This object is achieved for the fire detectors in that a matrix is stored in the memory, wherein the matrix contains combination values, wherein one of the combination values can be allocated by means of the matrix to the measured temperature and to the measured smoke density, wherein the combination value indicates the exceeding or understepping of the temperature threshold value and/or the smoke density threshold value. The temperature threshold value is preferably dependent on the smoke density in such a way that, the higher the measured temperature, the lower the smoke density values which suffice to trigger an alarm. The smoke density threshold value is preferably dependent on the temperature in such a way that, the higher the measured smoke density, the lower the measured temperatures which suffice to trigger an alarm. As a result, a distinction can be made between smoke sources which, however, result in no temperature increase, and real fires, which also result in a temperature increase. Even if a maximum smoke density threshold value, on the reaching of which an alarm is always triggered, has not yet been reached, a fire can be inferred on the basis of the measured temperature. However, if the home is only slightly filled with smoke, for example if a meal in the oven or on the hob is burnt, and no temperature increase is established, no alarm is triggered. The exceeding of the temperature threshold value and/or the smoke density threshold value is verifiable in a simple manner by means of a matrix. The fire detector has a memory, wherein the matrix is stored in the memory. The matrix contains combination values. One of the combination values can be allocated by means of the matrix to the measured temperature and to the measured smoke density, wherein the combination value indicates the exceeding or understepping of the temperature threshold value and/or the smoke density threshold value. A recalculation of the temperature threshold value and/or the smoke density threshold value for each measurement is therefore no longer required.

The fire detector preferably has a first radio means, wherein, following an initial commissioning, the fire detector is configurable with further fire detectors via the first radio means to form a radio network. Furthermore, each fire detector preferably has a second radio means, wherein, for example, in the event of an alarm, a message is transmittable via the second radio means to a destination address. The second radio means is designed to communicate with a base station or BTS. This has the advantage that the fire detectors themselves act as a transmission unit. A separate transmission unit for transmitting the message to the destination address is no longer necessary. Through the transmission of the alarm information to the destination address, the message is preferably forwarded to a monitoring control center. The destination address may be the address of the monitoring control center or the address of a mobile telephone, a fixed network telephone, an IP address or the like. The messages may be data, text, voice or video messages. Since all fire detectors can provide a connection to the monitoring control center via the second radio means, the susceptibility to failure of the connection of the network to the monitoring control center is minimized. Even if one or more fire detectors cannot set up a connection to the monitoring control center via the second radio means, a message or alarm information can be forwarded via the first radio means to the further fire detectors, so that the further fire detectors can forward the message via the second radio means to the monitoring control center. The use of a multiplicity of fire detectors which are automatically reciprocally interconnected using radio technology to form a meshed network and which also act as transmission relays for one another results in a reduced susceptibility to failure compared with a single transmission unit. The system proposed here is furthermore designed according to the invention in such a way that it checks itself in a periodically recurring manner for its functional reliability. The totality of the fire detectors form a self-organizing monitoring and alarm system, comprising at least one, but, in practice, a plurality of fire detectors of the same type, which are designed in such a way that, with the commissioning within a room unit to be secured, for example a home or building, they configure themselves independently to form a meshed ad hoc radio network with the aim of monitoring these premises for unwanted conditions using any given measurement technology, in particular, however, also simultaneously both acoustic and optical and also chemical, and, in the event of predefined values being exceeded or understepped, signal this condition to one or more predefined destination addresses or to the monitoring control center. A fire detector or a monitoring and alarm system of this type can also forward measurement values of other systems individually and also in a periodically recurring manner as relays, such as e.g. electricity meters, water meters or thermal elements of heating systems. The first radio means is designed for local communication with the other fire detectors. The first radio means is preferably designed as an ISM module. The second radio means is designed to communicate with an external base station of an in particular public mobile radio network. The second radio means has, in particular, a higher maximum transmit power than the first radio means. The first radio means is designed in particular as a short-range radio means for short-range radio. Short-range radio means of this type are also referred to as SRDs (Short Range Devices) or LPDs (Low Power Devices). The maximum transmit power of short-range radio means is regulated in national provisions. In Germany, for example, the maximum transmit power is 10 mW in the 433.05 to 434.79 MHz frequency range. The second radio means is preferably designed as a GSM module and/or as a UMTS module. The maximum transmit power of a GSM radio means is, for example, 2 watts in the uplink. The initially mentioned disadvantages are therefore avoided and corresponding advantages are achieved.

There are then a multiplicity of possibilities for designing and further developing the fire detector according to the invention in an advantageous manner. For this purpose, reference should first be made to the patent claims subordinated to patent claim 1. A preferred design of the invention will now be explained in detail below with reference to the drawing and the associated description. In the drawing:

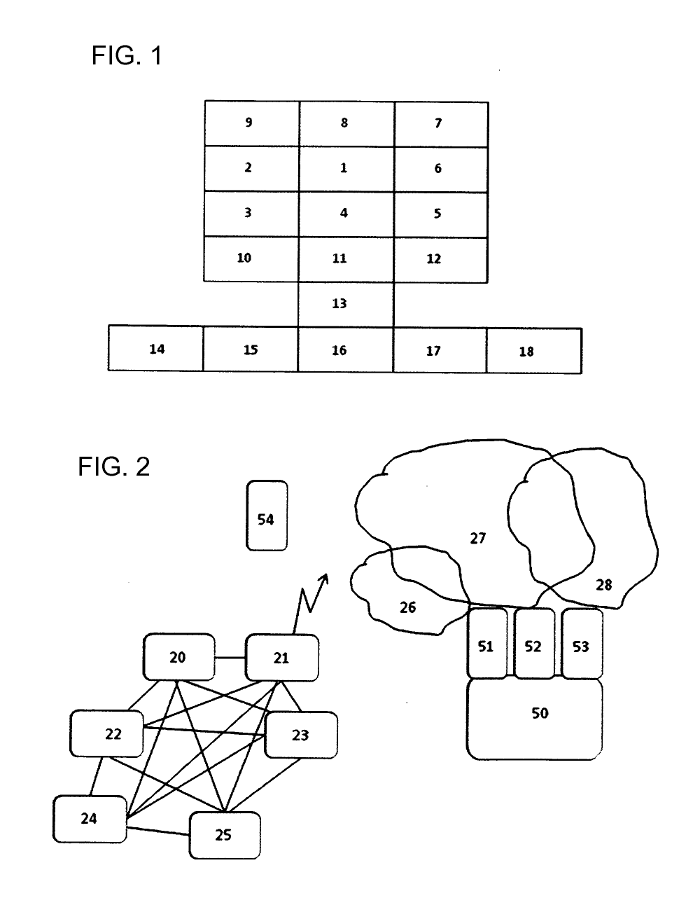

FIG. 1 shows, in a highly schematic representation, an overview of the essential components of a fire detector,

FIG. 2 shows, in a highly schematic representation, a plurality of fire detectors connected to form a radio network, and

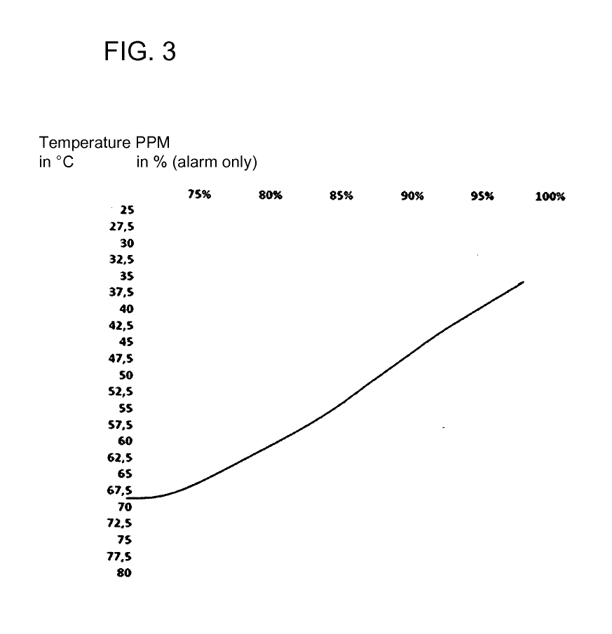

FIG. 3 shows, in a schematic diagram, the temperature-smoke density matrix.

FIG. 2 shows a plurality of fire detectors 20, 21, 22, 23, 24 and 25. The fire detectors 20, 21, 22, 23, 24 and 25 are, in particular, of identical design. FIG. 2 shows six fire detectors 20 to 25. The number of fire detectors 20 to 25 can, however, also be less than or greater than six.

The fire detectors 20 to 25 serve to monitor a room (not shown in detail) and to trigger an alarm. The fire detectors 20 to 25 are designed in particular to trigger a fire alarm. For monitoring fires, the fire detector 20 to 25 is preferably but not necessarily to be installed centrally in each case centrally on a room ceiling of a room to be monitored.

The essential components of the fire detectors 20 to 25 can be explained below with reference to FIG. 1:

Each of the fire detectors 20 to 25 described here preferably has a housing and a motherboard (not shown).

The fire detectors 20 to 25 in each case preferably have a controller 1. The controller 1 serves to control and regulate the fire detectors 20 to 25. The fire detectors 20 to 25 can in each case have an operating system and programs, wherein the operating system and the programs are executable with the controller 1.

Each fire detector 20 to 25 has at least one sensor. The sensor can be designed, in particular, as a smoke sensor 2. A smoke density can be recorded as a measurement value with the smoke sensor 2. The smoke sensor 2 can be designed, in particular, as an optical sensor (not shown in detail) and can be disposed in a measurement chamber. Light pulses are generated in the measurement chamber. In the smoke-free condition of the measurement chamber, these light pulses do not fall onto the optical sensor. If smoke enters the measurement chamber, the light pulse is scattered by the smoke. The scattered light then falls onto the optical sensor. The scattered light strength is used to determine the smoke density.

The fire detectors 20 to 25 preferably have a temperature sensor 3 as a further sensor. The ambient temperature of the fire detectors 20 to 25 can be recorded as a measurement value with the temperature sensor 3.

The fire detectors 20 to 25 have a piezo element 4. An audible alarm signal can be emitted via the piezo element 4 if an alarm is triggered by the exceeding or understepping of a limit value.

The fire detectors 20 to 25 preferably have a loudspeaker 5. The fire detectors 20 to 25 preferably have a microphone 6. The rooms can be acoustically monitored by the microphone 6. The fire detectors 20 to 25 are usable with the loudspeaker 5 and the microphone 6 as a transmit and/or receive part of a babyphone. Furthermore, a voice connection can be provided with the loudspeaker 5 and the microphone 6. It is conceivable to provide a voice connection between different fire detectors 20 to 25 and/or between one of the fire detectors 20 to 25 and the destination address.

The fire detectors 20 to 25 have, in particular, a light source 8. The light source 8 can be activated particularly when an alarm is triggered. The light source 8 then illuminates the room to be monitored. The activated light source 8 simplifies orientation particularly when smoke has already penetrated into the room. The linking of the light source 8 with the triggering of the alarm makes it easier to find an emergency exit and therefore increases safety.

The fire detectors 20 to 25 have a power source 9. The power source 9 can be formed by batteries or accumulators.

The fire detectors 20 to 25 have a first radio means 11. Following an initial commissioning, the fire detectors 20, together with the further fire detectors 21 to 25, are configured via the first radio means 11 to form a radio network. This is indicated in FIG. 2 by the connection lines between the fire detectors 20 to 25. The first radio means 11 is preferably designed for local communication with the other fire detectors 20 to 25. The first radio means 11 is designed as a short-range radio means, preferably as an ISM module. The first radio means 11 has, in particular, a synchronization unit, so that the fire detectors 20 to 25 can be synchronized immediately following the activation, preferably via the ISM band. If the fire detectors 20 to 25 are activated successively, the transmit and receive cycles of the first radio means 11 are synchronized with one another within a specific initialization time span.

The fire detectors 20 to 25 have a memory 10. A routing table is storable in the memory 10. Furthermore, predefined threshold values are stored in the memory 10. In particular, an individual identification feature is allocated in each case to each of the fire detectors 20 to 25. Within the initialization time span, the identification feature is exchanged with all adjacent fire detectors 20 to 25 to which a radio connection of sufficient quality is possible via the first radio means 11. A routing table is set up in each fire detector 20 to 25. The routing table is stored in the memory 10. The routing table contains information on all connection possibilities in the local radio network.

The fire detectors 20 to 25 in each case have at least one operating element 12, preferably a plurality of operating elements 12. An alarm can be disabled with the operating element 12.

The fire detectors 20 to 25 in each case have an internal bus system 13. The bus system is used for data transmission between a plurality of modules and the controller 1. The bus system 13 connects, in particular, a plurality of slots, wherein further modules can be accommodated in the slots. The fire detectors 20 to 25 can thus be individually adapted and retrofitted or upgraded with further modules. This opens up a multiplicity of application possibilities for the fire detectors 20 to 25.

The fire detectors 20 to 25 preferably have a camera 14. The room to be monitored can be viewed by means of the camera 14. The image recorded by the camera 14 can be forwarded via the first radio means 11 within the radio network. The camera 14 is preferably connected via a slot to the bus system 13. The camera 14 can be used for intruder monitoring of the room.

Furthermore, the fire detectors 20 to 25 can have a movement detector 15. Furthermore, the fire detectors 20 to 25 can have a light sensor 16. The movement detector 15 is preferably connected via a slot to the bus system 13.

Furthermore, the fire detectors 20 to 25 can have a gas sensor 17. Carbon dioxide is produced by a fire. The gas sensor 17 can be designed to detect carbon dioxide. It is conceivable that the fire detectors 20 to 25 have further sensors 18. The gas sensor 17 and/or the further sensors 18 are preferably connected via a slot to the bus system 13.

If a specific threshold value is exceeded or understepped, a message is transmittable with alarm information to at least one destination address. This is indicated in FIG. 2 by the arrow emerging from the fire detectors 21 (not shown in detail).

It is particularly advantageous that a second radio means 7 is provided (cf. FIG. 1), wherein the alarm information is transmittable via the second radio means 7 to the destination address. This has the advantage that the fire detectors 20 to 25 can all transmit the alarm information of the ad hoc network separately to the destination address. The second radio means 7 is designed in particular as a GSM module and/or as a UMTS module. The second radio means 7 has a SIM card. The second radio means 7 transmits the alarm information to an external base station (not shown) of a mobile radio network 26. The alarm information 26 is forwarded via the mobile radio network 26 to the monitoring control center 50.

The monitoring control center 50 preferably has a mobile radio access 51, in particular a GSM/UMTS access. The alarm information and further messages are forwardable via the mobile radio network 26 and the mobile radio access 51, for example via SMS and/or MMS, to the monitoring control center 50. Furthermore, a voice connection can be set up to each of the fire detectors 20 to 25 via the mobile radio network 26. A unique identification feature (not shown) is allocated to each of the fire detectors 20 to 25. Each fire detector 20 to 25 has a SIM card with a call number. The call number preferably serves as an identification feature.

The monitoring control center 50 has an Internet access 52. The Internet access 52 can be provided by a DSL connection and a computer. The second radio means 7 can forward a message via the mobile radio network 26 and via a suitable interface to the Internet 27, and further via the Internet access 52 to the monitoring control center 50.

The monitoring control center 50 has a telephone fixed network access 53, which is also referred to as a PSTN (Public Switched Telephone Network) access. The telephone fixed network access 53 can be contacted via the second radio means 7 and corresponding interfaces. The second radio means 7 can set up a voice connection via the mobile radio network 26 and the PSTN network 28 to the monitoring control center 50.

Through the transmission of the alarm information to the destination address, the alarm information is preferably forwarded to the monitoring control center 50 (cf. FIG. 2). Since all fire detectors 20 to 25 can provide a connection to the monitoring control center 50 via the second radio means 7, the susceptibility to failure of the connection of the network to the monitoring control center 50 is minimized. Even if one or more fire detectors 20 to 25 cannot set up a connection to the monitoring control center 50 via the second radio means 7, alarm information or a different message can be forwarded via the first radio means 11 to the further fire detectors 20 to 25 so that the further fire detectors 20 to 25 can forward the alarm information via the second radio means 7 to the monitoring control center 50. The multiplicity of fire detectors 20 to 25, automatically reciprocally interconnected using radio technology to form a meshed radio network and also acting as transmission relays for one another, results in a reduced susceptibility to failure compared with a single transmission unit. The system proposed here is furthermore preferably designed so that it checks itself in a periodically recurring manner for its functional reliability.

Following installation, the fire detectors 20 to 25 are activated successively. Following the activation, a predefined initialization time span begins. The initialization time span can, for example, be around 5-10 minutes. Within the initialization time span, following the activation, all fire detectors 20 to 25 are synchronized successively via the first radio means 11, i.e. in particular via the ISM band, in such a way that they synchronize the transmit and receive cycles with one another, exchange the respective uniquely allocated identification feature, preferably the SIM card call numbers, with all adjacent fire detectors 20 to 25 to which a radio link of sufficient quality is possible, and store them in their routing table.

On completion of this procedure, the second radio means 7, in particular the GSM/UMTS modules, are activated, preferably via the controller 1, and are caused to set up a connection to the respective BTS of the mobile radio network operator. The connection quality is preferably determined here via the second radio means 7 to the BTS. The connection quality is verifiable via the second radio means 7, i.e. whether a possibility exists for direct connection to a base station of the mobile radio network 26. The connection quality is preferably forwarded to the controller 1 and to the memory 10. The memory 10 is preferably designed as a flash memory. This has the advantage that data, for example the routing table and the matrix, are storable in the memory 10 in non-volatile form, i.e. are storable without a permanent supply voltage.

Each fire detector 20 to 25 preferably establishes how good its connection is via the second radio means 7 or its GSM/UMTS connection into the respective mobile radio network 26. Due to the respective physically different position in the home or the building due to the associated greater or lesser attenuation through the fabric of the building, the connection quality is better or worse to even totally inadequate for any GSM/UMTS connection at all to the BTS.

In the event that one of the second radio means 7 or a GSM/UMTS module of one of the fire detectors 20 to 25 cannot set up an adequate connection to a BTS, this fire detector 20 to 25 preferably signals this to the other fire detectors 20 to 25 to which this fire detector 20 to 25 has a good connection via the first radio means 11 or via the ISM connection according to the routing table.

The adjacent fire detector 20 to 25 with the best connection via the first radio means 11 or with the best ISM connection (high signal level, low bit error rate) to the fire detector 20 to 25 which cannot set up a connection via the second radio means 7 or a GSM/UMTS connection, is preferably activated as a relay for the latter.

The consequence of this is that all messages, such as a cyclically polled function testing result of the system concerned, the battery charging condition, the exceeding of a predefined measurement value, the two-way voice transmission, the image transmission from the camera 14 and other measurement values are transmitted via the first radio means 11—via the ISM band—from the “connectionless” fire detector 20 to 25 which has no GSM/UMTS connection to this “connected” adjacent fire detector 20 to 25 which has “declared” itself as a relay, so that this adjacent fire detector 20 to 25 then transmits these messages to the monitoring control center 50.

On completion of the configuration of all of any given number of installed fire detectors 20 to 25 to form a meshed radio network, each fire detector 20 to 25 preferably indicates optically, by means of indicating cyclical illumination or the like, whether the meshed radio network is or is not yet completely figured.

Following successful configuration of the meshed radio network, each fire detector 20 to 25 preferably measures, essentially at sufficiently short intervals, the respective smoke density via the smoke sensor 2 specifically provided for that purpose and also simultaneously the respective temperature via the temperature sensor 3. If a temperature threshold value is exceeded and a smoke density threshold value is exceeded, an alarm is triggerable.

The temperature threshold value is dependent on the smoke density and/or the smoke density threshold value is dependent on the temperature. The temperature threshold value is dependent on the smoke density and the smoke density threshold value is dependent on the temperature. This has the advantage that the risk of false alarms is significantly reduced.

The initially mentioned disadvantages are now avoided in that the matrix is stored in the memory 10, wherein the matrix contains combination values, wherein one of the combination values can be allocated by means of the matrix to the measured temperature and to the measured smoke density, wherein the combination value indicates the exceeding or understepping of the temperature threshold value and/or the smoke density threshold value.

The fire detector 20 to 25 has the memory 10, wherein a matrix is stored in the memory 10. The matrix contains combination values, wherein one of the combination values can be allocated by means of the matrix to the measured temperature and to the measured smoke density. The combination value indicates the exceeding or understepping of the temperature threshold value and/or the smoke density threshold value.

The measured temperature and the measured smoke density are compared with temperature-dependent and smoke-density-dependent threshold values. The measured temperature and smoke density are thereby correlated with one another. The measured temperature and smoke density are correlated with one another in their dynamic progression. The correlation is preferably carried out by means of the matrix shown in FIG. 3.

The combination values form a measure for the fire probability, taking into account the correlation of the temperature and the smoke density. By means of the matrix, one of the combination values can in each case be allocated to the measured temperature and to the measured smoke density. An alarm is triggerable depending on the coordination value.

The temperature threshold value falls with rising smoke density. The higher the measured smoke density, the lower the measured temperatures which are sufficient to trigger an alarm. The temperature threshold value is a preferably uniformly falling function of the smoke density.

The smoke density threshold value falls with rising temperature. The higher the temperature, the lower the smoke density values which are sufficient to trigger an alarm. The smoke density threshold value is a preferably uniformly falling function of the temperature.

Insofar as the smoke density threshold value and/or the temperature threshold value occur as a mathematical function, the temperature threshold value and/or the smoke density threshold value can be calculated in each case with the fire detector 20 to 25 for each measured temperature and smoke density. However, a simpler method is described below, wherein the threshold values do not need to be recalculated each time, but rather the exceeding and understepping of the smoke density threshold value and the temperature threshold value are determinable with reference to a matrix.

A ratio or ratio interval of the measured smoke density is allocated to each column of the matrix as a percentage for a maximum smoke density threshold value. If this ratio is 100%, or if the measured smoke density value exceeds the maximum smoke density threshold value, an alarm is triggered.

If the measured smoke density is less than the maximum smoke density threshold value, the correlation is determined with the matrix. A temperature or temperature interval, for example 25° C. to 27.5° C., or 27.5° C. to 30° C., is allocated to each row of the matrix. A combination value can thus be allocated to each pair value comprising the measured smoke density and the measured temperature. The matrix contains the combination values. The combination value indicates the exceeding or understepping of the temperature threshold value and/or the smoke density threshold value.

The combination values therefore map the correlation of the smoke density with the temperature. FIG. 3 contains a borderline (not shown in detail), wherein this borderline indicates that the temperature threshold value is dependent on the smoke density and the smoke density threshold value is dependent on the temperature. All pair values comprising the measured smoke density and the measured temperature below the borderline result in the triggering of an alarm. All pair values above the borderline do not result in the triggering of an alarm. All pair values comprising the measured smoke density and the measured temperature on the one side of the borderline result in the triggering of an alarm. All pair values on the other side of the borderline do not result in the triggering of an alarm.

This matrix (FIG. 3) maps the empirical smoke density values and also the empirical temperature values onto a combination value. A fire can be inferred in each case with sufficient probability from this combination value.

Fires are thus recognized by their increasingly dynamic heat build-up, even if the inference from the smoke density alone does not yet allow a sufficient maximum threshold value for a fire, unlike the parallel-running actual measurement value build-up of the smoke density in the alignment with the temperature build-up and vice versa.

According to the invention, fires are also recognized not only by their increasingly dynamic smoke density, but rather already before a maximum threshold value for the smoke density is reached, since, in parallel, a sufficiently dynamic rise in temperature already indicates this.

If even only one predefined threshold value, measured by one of the fire detectors 20 to 25, is reached, the measurement values of the other fire detectors 20 to 25 belonging to the radio cluster are preferably checked, even if they have not yet reached a threshold value set therein. At the same time, a—preferably digital—image can be recorded by one of the fire detectors 20 to 25 equipped with a camera 14 and sent to the monitoring control center 50, for example via MMS. If a GSM/UMTS connection or a different connection of these fire detectors 20 to 25 into the mobile radio network 26 or a different network is not available via the second radio means 7, it is sent via the first radio means 11 (ISM module) or a different cable to one or more fire detectors 20 to 25 in such a way that one of the fire detectors 20 to 25 with a mobile radio connection also carries out the image transmission (MMS) via the second radio means 7 (GSM/UMTS or similar).

The same applies in the case where a threshold value in one of the fire detectors 20 to 25 is reached. The order in which individual actions are carried out is preferably definable for the fire detectors 20 to 25.

For example, an audible alarm can initially be triggered via the piezo element(s) 4 in the one fire detector 20 to 25 which measured the exceeding of this threshold value.

The other fire detectors 20 to 25 contactable via the first radio means 11 or controlled via radio (ISM) and belonging to the unit of the local radio cluster can then be notified, so that the other fire detectors 20 to 25 also trigger an audible alarm.

If the audible alarm is not disabled mechanically via one of the operating elements 12 within a predefined time span, e.g. 30 to 60 seconds, a GSM/UMTS alarm is transmitted by one or all of the fire detectors 20 to 25 belonging to the cluster via the second radio means 7. Alternatively, only predefined, special individual fire detectors 20 to 25 can also transmit the alarm via the second radio means 7.

However, these actions can also take place in a temporally reversed sequence or in parallel; this is individually scalable.

The same applies to the setting up of a preferably two-way voice connection via the second radio means 7 or via GSM/UMTS to any given predefinable telephone connection, or a plurality of telephone connections both temporally parallel and sequential, and preferably also via SMS or a different digital transmission method to any given predefinable addressee such as, e.g., also to one or more automatic devices for further instigation.

To summarize, it can be stated as follows:

In the basic configuration, the fire detectors 20 to 25 are of identical design. The fire detectors 20 to 25 are used for smoke density monitoring in the simultaneous alignment with temperature monitoring. The measured smoke densities and the measured temperatures are correlated with one another. A combination value, in particular, is allocated to these pair values. On the basis of the combination value, initially an audible alarm and, in parallel or later, a radio alarm is triggerable via a second radio means 7. This second radio means 7 can be designed as a GSM module.

It is provided that a plurality of the fire detectors 20 to 25 communicate with one another within a defined initialization time span following the initial commissioning via a first radio means 11 in such a way that a routing table is created in each fire detector 20 to 25. From the routing table, each fire detector 20 to 25 can read whether this fire detector 20 to 25 can itself transmit a (GSM) radio alarm directly via the second radio means 7, or whether this can be only done, for example due to attenuation through masonry, via a different fire detector 20 to 25 as a relay. From the routing tables, each fire detector 20 to 25 can furthermore read for which other of the fire detectors 20 to 25 of the thus created meshed radio cluster this fire detector 20 to 25 can itself possibly act as a relay. The routing table contains information on all connections within the network via the first radio means 11 and preferably information on all possible connections via the second radio means 7 to the BTS.

These fire detectors 20 to 25, interconnected in this way using radio technology to form a meshed radio cluster or radio network, are, in particular, designed in such a way that, in the event of an outgoing alarm to the monitoring control center 50, preferably a GSM radio alarm, only one of the fire detectors 20 to 25 and also all other fire detectors 20 to 25 belonging to the cluster trigger such an alarm, preferably a GSM radio alarm. The respective measurement values of the individual fire detectors 20 to 25 are transmitted to this monitoring control center 50. The network or cluster or radio cluster is formed by the first radio means 11. The monitoring control center 50 initiates an intervention, for example by the fire service or police, and forwards the respective measurement values from all rooms to the intervention services.

Each fire detector 20 to 25 preferably contains a unique identification feature, for example a SIM card or a SIM chip, to which the precise position in the building is forwarded by the user to the monitoring control center 50 immediately following the installation.

The fire detector 20 to 25 preferably contains a loudspeaker 5 and a microphone 6, controlled by either the contained second radio means 7—the GSM module—or, where the second radio means 7 has no connection to the mobile radio network 26, controlled via the first radio means 11—the ISM module—, so that, with all fire detectors 20 to 25 belonging to the respective cluster, a two-way voice connection is set up to the monitoring control center 50 or to another destination address.

The fire detector 20 to 25 contains a light source 8. The light source 8 can be designed, in particular, as an LED. In the event of an alarm, the LED or light source 8 lights up in each fire detector 20 to 25 belonging to the cluster. The fire detector 20 to 25 is preferably scalable to accommodate further modules such as the movement detector 15 and the camera 14 (for intruder monitoring), but is also suitable for gas sensors 17 or other sensors 18.

A remote control enables the activation and de-activation of individual modules and their functions and a babyphone remote monitoring via one or more mobile telephones 54 and/or via devices connected to the Internet. The remote control is preferably designed as a radio remote control for communication via the first radio means 11. The remote control is preferably designed as an ISM remote control.

For the present invention, the following abbreviations and expressions are to be understood as follows:

GSM=Global System for Mobile Communication

GPRS=General Packed Radio Service

UMTS=Universal Mobile Telecommunication System

EDGE=Enhanced Date Rates for GSM Evolution

ISM=Industrial Scientific and Medical Band

SMS=Short Message Service

MMS=Multimedia Messaging Service

PSTN=Public Service Telephone Network

IP=Internet Protocol

DSL=Digital Subscriber Line

BTS=Base Transceiver Station

### LIST OF REFERENCE NUMBERS

1 Controller

2 Smoke sensor

3 Temperature sensor

4 Piezo element

5 Loudspeaker

6 Microphone

7 Second radio means

8 Light source

9 Power source

10 Memory

11 First radio means

12 Operating elements

13 Bus system

14 Camera

15 Movement detector

16 Light sensor

17 Gas sensor

18 Further sensors

20 Fire detector

21 Fire detector

22 Fire detector

23 Fire detector

24 Fire detector

25 Fire detector

26 Mobile radio network

27 Internet

28 PSTN network

50 Monitoring control center

51 Mobile radio access

52 Internet access

53 Telephone fixed network access

54 Mobile telephone

1-14. (canceled)

15. A fire detector for monitoring a room and for triggering a fire alarm, the fire detector comprising:
a smoke sensor for measuring a smoke density;
a temperature sensor for measuring a temperature;
an alarm, wherein, if a temperature threshold value is exceeded and/or a smoke density threshold value is exceeded, said alarm is triggerable, the temperature threshold value being dependent on the smoke density and/or the smoke density threshold value is dependent on the temperature; and
a memory storing a matrix, the matrix containing combination values, wherein one of the combination values can be allocated by means of the matrix to the temperature measured and to the smoke density measured, wherein a combination value indicates an exceeding or an under-stepping of the temperature threshold value and/or the smoke density threshold value.

16. The fire detector according to claim 15, wherein the temperature threshold value is dependent on the smoke density in such a way that, a higher the temperature measured, a lower the smoke densities must be which are sufficient to trigger said alarm.

17. The fire detector according to claim 15, wherein the smoke density threshold value is dependent on the temperature in such a way that, a higher the smoke density measured, a lower the measured temperatures must be which are sufficient to trigger said alarm.

18. The fire detector according to claim 15, further comprising a first radio means, wherein, following an initial commissioning, the fire detector is configurable with further fire detectors via said first radio means to form a radio network.

19. The fire detector according to claim 18, further comprising a second radio means, wherein a message is transmittable via said second radio means to at least one destination address.

20. The fire detector according to claim 18, wherein said first radio means is a short-range radio means.

21. The fire detector according to claim 19, wherein said second radio means is configured for communication with a base station of a mobile radio network.

22. The fire detector according to claim 18, wherein said memory stores a unique identification feature allocated to the fire detector, wherein identification features are exchangeable with further fire detectors within an initialization time span via said first radio means, wherein a routing table is creatable and stored in said memory.

23. The fire detector according to claim 19, wherein the fire detector is configured to receive messages from other fire detectors via said first radio means, and the messages are forwardable via said second radio means to the destination address.

24. The fire detector according to claim 21, wherein a connection quality is verifiable via said second radio means, wherein it can be verified whether a possibility for direct connection to the base station of the mobile radio network exists.

25. The fire detector according to claim 15, further comprising a gas sensor.

26. The fire detector according to claim 15, further comprising a loudspeaker and a microphone.

27. The fire detector according to claim 15, further comprising a two-way voice connection set up to a monitoring control center or to another destination address.

28. The fire detector according to claim 15, further comprising a light source, wherein said light source being activated by a triggering of said alarm.

29. The fire detector according to claim 18, wherein said short-range radio means is an industrial scientific and medical band (ISM) module.

30. The fire detector according to claim 19, wherein said second radio means is selected from the group consisting of a global system for mobile communications (GSM) module and a universal mobile telecommunication system (UMTS) module.

31. The fire detector according to claim 28, wherein said light source is a light emitting diode.
